(19) United States
(12) Patent Application Publication
(10) Pub. No.: US 2018/0313373 A1
(43) Pub. Date: Nov. 1, 2018

(54) EQUIPMENT AND METHOD FOR SUPERVISING VALVES IN A HYDRAULIC CIRCUIT, ASSOCIATED HYDRAULIC CIRCUIT AND COMPUTER PROGRAM PRODUCT

(71) Applicant: AREVA NP, Courbevoie (FR)

(72) Inventors: Dominique PINET, SARTROUVILLE (FR); Jean Reynald MACE, PALAISEAU (FR); Jocelyn PERISSE, LYON (FR); Thierry DECHANET, CHARVIEU-CHAVAGNEUX (FR)

(21) Appl. No.: 15/735,601

(22) PCT Filed: Jun. 10, 2016
(86) PCT No.: PCT/EP2016/063330

§ 371 Date: Dec. 11, 2017

(30) Foreign Application Priority Data
Jun. 12, 2015 (FR) FR 15 55401

(51) Int. Cl. F15B 21/02; F16K 37/00; F15B 19/00; F15B 21/08; G05B 15/02

(52) U.S. Cl. CPC F15B 21/02; F16K 37/0041; F15B 19/005; F15B 2211/86; F15B 21/08; G05B 15/02; F15B 2211/857; F15B 19/007

(57) ABSTRACT

Electronic equipment (12) for supervising valves (11) of a hydraulic circuit (10), wherein each valve (11) is movable between an open position and a closed position, includes a plurality of electronic devices for detecting changes in position (16), each being associated with a valve (11) and is configured to detect a change of position of the valve (11) between its open and closed positions, an electronic apparatus (18) for supervising the valves (11), and a system (20) for radio transmission of messages between each detection device (16) and the supervisory apparatus (18). The supervisory apparatus (18) is configured to calculate a sequence of successive changes of valve positions (11) from messages received from the detection devices (16) via the radio transmission system (20), to compare the sequence calculated with a predefined sequence, and to generate a signal as a function of the comparison.

The present invention relates to an electronic system for supervising the valves of a hydraulic circuit, each valve being movable between an open position and a closed position.

The equipment comprises, a plurality of electronic devices for detecting changes in position, each being associated with a respective valve and is configured to detect a change of position of the valve between its open position and its closed position, an electronic apparatus supervising hydraulic circuit valves; and a radio transmission system transmitting messages between each detection device for detecting changes in position and the supervisory apparatus.

The invention also relates to a hydraulic circuit comprising a plurality of valves and such valve supervisory equipment.

The invention also relates to a method for supervising the valves of such a hydraulic circuit, the method being implemented by computer.

The invention also relates to a computer program product comprising software instructions which, when executed by a computer, implement such a supervisory method.

The invention relates to the field of the supervision of hydraulic circuits, preferably in a closed environment inside a building, particularly in a harsh environment, such as a nuclear reactor building.

### BACKGROUND

Document EP 2 126 434 B1 discloses electronic supervisory equipment of the aforementioned type. The supervisory equipment described in this document comprises a plurality of valve control devices, also referred to as a safety valve, and one or more valve device readers for receiving status messages from the valve control devices and for transmitting them to a server via an Ethernet communication. Each valve control device comprises a sensor for measuring the angular position of the valve and a short-range wireless communication unit for transmitting a status message to one or more valve device readers, particularly when a change in the angular position of the corresponding valve is detected. Each status message comprises the angular position of the valve as measured by the sensor, together with identification of the valve control device.

The supervisory equipment also comprises one or more portable operator devices, each of which is used to trigger a selected valve control device when it is nearby, in order to initiate a short-range status message communication and to receive the status message via the operator device.

However, the supervision of the hydraulic circuit performed using such equipment is not optimal, and incidents are likely to occur during valve maneuvering by operators.

### SUMMARY OF THE INVENTION

In this context, equipment and a method are provided for supervising the valves of a hydraulic circuit, while making it possible to enhance the supervision of the hydraulic circuit by limiting the risks of an incident during valve maneuvers by operators.

For this purpose, the equipment is electronic equipment for supervising the valves of a hydraulic circuit, each valve being movable between an open position and a closed position, the equipment comprising:
a plurality of electronic devices for detecting changes in position, each being associated with a respective valve and is configured to detect a change in position of the valve between its open position and its closed position,
an electronic apparatus for supervising the valves of the hydraulic circuit, and
a radio transmission system for messages between each device for detecting changes in position and the supervisory apparatus,

wherein the supervisory apparatus is configured to calculate a sequence of successive changes of valve position based on messages received from the devices for detecting changes in position via the radio transmission system, to compare the calculated sequence with a predefined sequence, and to generate a signal based on the comparison between the calculated sequence and the predefined sequence.

The supervisory equipment then makes it possible to calculate the sequence of successive modifications of the valve positions from the messages received from the devices for detecting changes in position, i.e. as the valves are operated by the operator(s), to compare the calculated sequence with a predefined desired sequence, and to assist the operator(s) by generating a signal resulting from the comparison made between the calculated sequence and the predefined sequence.

The signal generated is, for example, a warning signal or an operating signal. The warning signal is generated in the event of detection of a difference between the calculated sequence and the predefined sequence, enabling the operator who is informed of this incident via the warning signal, to then correct it quickly. The operating signal indicates the next valve to be operated according to the predefined desired sequence, and the operator is then informed of the next valve to be opened or closed. The predefined desired sequence is also referred to as valve alignment or lineage.

In some embodiments, the supervisory equipment comprises one or more of the following characteristics, taken separately or in any technically feasible combination:
the signal generated is a warning signal in the event of detection of a difference between the calculated sequence and the predefined sequence;
the signal generated is an operating signal indicating the next valve to be operated according to the predefined sequence;
the supervisory apparatus is further configured to identify the valve corresponding to the generated signal;
the supervisory apparatus is further configured to transmit, via the radio transmission system, the generated signal to the device for detecting changes in position associated with the valve corresponding to the signal;
the equipment furthermore comprises an electronic tablet, and the supervisory apparatus is further configured to transmit, via the radio transmission system, the generated signal to the electronic tablet;
the equipment furthermore comprises at least one indicator light, each indicator lamp being associated with a corresponding valve, and the supervision device is furthermore configured to transmit, via the radio transmission system, to the indicator light associated with the valve. corresponding to the generated signal, a control signal for the generation by the indicator of a light signal;
the equipment furthermore comprises at least one loudspeaker, each loudspeaker being associated with a corresponding valve, and the supervisory apparatus is further configured to transmit, via the radio transmission system, to the associated loudspeaker at the valve corresponding to the generated signal, a control signal for the generation of a sound signal by the loudspeaker;
wherein each valve is movable in rotation about an axis of rotation between the open position and the closed position, and wherein each device for detecting changes in position comprises an accelerometer configured to detect an angular acceleration of the valve around the axis of rotation;
wherein each device for detecting changes in position furthermore comprises a power supply module and a calculation module configured to determine a change in position of the valve as a function of an angular acceleration detected by the accelerometer, while the power supply module is configured to electrically power the calculation module only in the event of detection of angular acceleration by the accelerometer;
wherein the radio transmission system comprises:
   a plurality of first short-range radio communication modules, each associated with a respective device for detecting changes in position, and
   at least one device for radio retransmission of messages between each first radio communication module and the supervisory apparatus, each retransmission device comprising:
      a second short-range radio communication module, configured to communicate with each first radio communication module, and
      a third long-range radio communication module, configured to communicate with the supervisory apparatus;
at least one retransmission device further comprises a base-shaped electrical connector for its power supply via an electrical power supply network of light sources;
wherein each third long-range radio communication module is configured to transmit and/or receive signals at a frequency below 1 GHz, preferably between 700 MHz and 1 GHz, more preferably equal to 870 MHz plus or minus 10%.

A hydraulic circuit is also provided comprising a plurality of valves and valve supervisory equipment, each valve being movable between an open position and a closed position, and wherein the equipment is as defined above.

A method is also provided for supervising valves of a hydraulic circuit, wherein each valve is movable between an open position and a closed position, the method being implemented by computer and comprising the following step:
acquiring messages transmitted by electronic devices for detecting changes in position, each device for detecting changes in position being associated with a respective valve and is configured to detect a change of position of the valve between its open position and its closed position, each message containing information relating to the position of the corresponding valve, wherein the method further comprises the steps of:
calculating a sequence of successive modifications of valve positions from the acquired messages,
comparing the calculated sequence with a predefined sequence, and
generating a signal as a function of the comparison between the calculated sequence and the predefined sequence.

A computer program product is provided comprising software instructions, which, when executed by a computer, implement a supervisory method as defined above.

### BRIEF SUMMARY OF THE DRAWINGS

These features and advantages of the invention will become apparent upon reading the description which follows, given solely by way of a non-limiting example, and with reference to the appended drawings, wherein:

FIG. 1 shows a schematic representation of electronic valve supervisory equipment of a hydraulic circuit according to an embodiment of the invention;

FIG. 2 shows a flow chart of a method, according to an embodiment of the invention for supervising the valves of the hydraulic circuit of FIG. 1.

### DETAILED DESCRIPTION

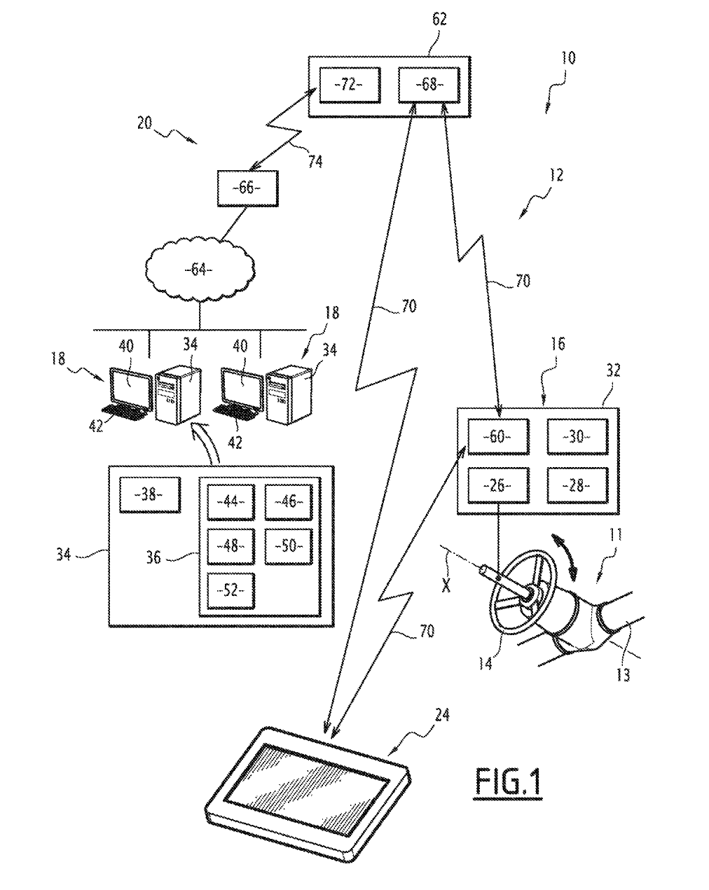

In FIG. 1, a hydraulic circuit 10 comprises a plurality of valves 11 and electronic equipment 12 for supervising the valves 11. A single valve 11 is shown in FIG. 1 for the sake of clarity of the drawing.

Each valve 11 is associated with a pipe 13, and is movable between an open position corresponding to the circulation of a fluid in the pipe 13 and a closed position corresponding to the absence of fluid circulation in the pipe 13.

Each valve 11 is preferably rotatable about an axis of rotation X between its open position and its closed position.

Each valve 11 is equipped with a control wheel 14 to operate between its open and closed positions.

The supervisory equipment 12 comprises a plurality of electronic detectors in the form of electronic devices for detecting changes in position 16, each being associated with a respective valve 11 and being configured to detect a change of position of the valve 11 between its open position and its closed position. For the sake of clarity of the drawing, FIG. 1 shows a single device for detecting changes in position 16.

The supervisory equipment 12 also comprises at least one electronic apparatus 18 for supervising the valves 11 of the hydraulic circuit and a system 20 for the radio transmission of messages between each device for detecting changes in position 16 and the supervisory apparatus(es) 18. In the example of FIG. 1, the supervisory equipment 12 comprises two supervisory apparatuses 18, each being connected to the radio transmission system 20.

In addition optionally, the supervisory equipment 12 further comprises an electronic tablet 24 that is intended to be used, for example, by an operator in charge of handling the valves 11.

In addition optionally, the supervisory equipment 12 comprises at least one indicator light, each indicator light being associated with a corresponding valve 11.

Alternatively or optionally in addition, the supervisory equipment 12 further comprises at least one loudspeaker, each loudspeaker being associated with a corresponding valve 11.

Each device for detecting changes in position 16 comprises a sensor that is configured to detect a movement of the corresponding valve 11 between its open position and its closed position. The sensor is, for example, an accelerometer 26 that is configured to detect an angular acceleration of the valve 11 around the axis of rotation X.

Each device for detecting changes in position 16 further comprises a power supply module 28 and a calculation module 30 configured to determine a change of position of the associated valve 11 as a function of a movement detected by the sensor, for example according to an angular acceleration detected by the accelerometer 26. Preferably, the power supply module 28 is configured to electrically power the calculation module 30 only in the event of the detection of a movement by the sensor, for example only in the event of the detection of an angular acceleration by the accelerometer 26. The accelerometer 26 is additionally configured to reactivate regularly, for example every tenth of a second, in order to detect any angular acceleration of the valve 11.

Each device for detecting changes in position 16 comprises a housing 32 inside which are arranged the sensor, such as the accelerometer 26, the power supply module 28 and the calculation module 30. The housing 32 is, for example attached to the control wheel 14 of the valve.

Each supervisory apparatus 18 comprises an information processing unit 34, in the form, for example, of a memory 36 and a processor 38 associated with the memory 36.

In addition optionally, each supervisory apparatus 18 comprises a display screen 40 and data input means, such as a keyboard 42.

Each supervisory apparatus 18 is configured to calculate a sequence of successive changes of valve positions 11 from messages received from the devices for detecting changes in position 16 via the radio transmission system 20, and then to compare the calculated sequence with a predefined sequence, and accordingly to generate a signal based on the comparison between the calculated sequence and the predefined sequence.

In addition optionally, each supervisory apparatus 18 is further configured to identify the valve 11 corresponding to the generated signal.

Again, in addition optionally, each supervisory apparatus 18 is further configured to transmit, via the radio transmission system 20, the signal generated to the device for detecting changes in position 16 associated with the valve 11 corresponding to the signal.

As a further optional addition, when the supervisory equipment 12 comprises the electronic tablet 24, each supervisory apparatus 18 is furthermore configured to transmit the generated signal to the electronic tablet 24 via the radio transmission system 20.

As a further optional supplement, when the supervisory equipment 12 comprises at least one indicator light, each supervisory apparatus 18 is furthermore configured to transmit, via the radio transmission system 20, to the indicator light associated with the valve 11 corresponding to the signal generated, a control signal for the generation of a light signal by the light indicator.

As a further optional addition, when the supervisory equipment 12 comprises at least one loudspeaker, each supervisory apparatus 18 is furthermore configured to transmit, via the radio transmission system 20, to the loudspeaker associated with the valve 11 corresponding to the generated signal, a control signal for the generation by the loudspeaker of a sound signal.

By way of example, the memory 36 is configured to store software 44 for calculating the sequence of successive changes in the positions of the valves 11 from the messages received from the devices 16 for detecting changes in position via the radio transmission system. 20. The memory 36 is also configured to store software 46 for comparing the calculated sequence with the predefined sequence, as well as software 48 for generating the signal as a function of the comparison between the calculated sequence and the predefined sequence.

In addition optionally, the memory 36 is configured to store software for identifying the valve 11 corresponding to the generated signal.

As a further optional addition, the memory 36 is configured to store software 52 for transmitting, with the aid of the radio transmission system 20, the generated signal to the device for detecting changes in position 16 associated with the valve 11 corresponding to the signal.

The processor 38 is capable of executing each of the software programs 44, 46, 48, 50, 52.

When executed by the processor 38, the calculation software 44, the comparison software 46, the generation software 48, if necessary, the identification software 50, and the transmission software 52 respectively form a calculation module configured to calculate the sequence of successive changes in the positions of the valves 11 from the messages received from the devices for detecting changes in position, a comparison module configured to compare the calculated sequence with a predefined sequence, a generation module configured to generate the signal as a function of the comparison between the calculated sequence and the predefined sequence, and, if necessary, an identification module configured to identify the valve 11 corresponding to the generated signal, and a transmission module configured to transmit the generated signal using the radio transmission system 20.

In addition optionally, the transmission module, formed for example by the transmission software 52 to be executed by the processor 38, is configured to transmit the generated signal to the electronic tablet 24, and/or to transmit the control signal to the associated indicator light at the valve 11 corresponding to the generated signal for the generation of a light signal by the indicator, and/or for transmitting a control signal for the generation by the loudspeaker of the sound signal, to the loudspeaker associated with the valve 11 corresponding to the generated signal.

As a variant, the calculation module, the comparison module, the generation module and, if applicable, the identification module and the transmission module, are implemented in the form of programmable logic components, such as FPGA (Field-Programmable Gate Array), or in the form of dedicated integrated circuits, such as ASIC (Application-Specific Integrated Circuit).

The generated signal is, for example, a warning signal, when a difference between the calculated sequence and the predefined sequence is detected.

Alternatively or additionally, the generated signal is an operating signal indicating the next valve 11 to be operated according to the predefined sequence. Persons skilled in the art will understand that the generation module is configured to generate one or more signals, i.e. the warning signal and/or the operating signal, resulting from the comparison between the calculated sequence and the predefined sequence.

The radio transmission system 20 comprises a plurality of first short range radio communication modules 60, each first module 60 being associated with a respective device for detecting changes in position 16. In the example of FIG. 1, the first communication module 60 is arranged inside the housing 32 of the associated device for detecting changes in position 16.

The radio transmission system 20 further comprises at least one device 62 for the retransmission of messages between each first radio communication module 60 and the supervisory apparatus(es) 18.

In the example of FIG. 1, the supervisory apparatuses 18 are each connected to a network 64, such as a local area network, for example to a wireless local area network (WLAN), i.e. a network that is compliant with IEEE 802.11, i.e. a Wi-Fi network.

In addition optionally, the radio transmission system 20 further comprises a gateway 66 for communication between the retransmission device 62 and the network 64.

Each retransmission device 62 is also called a repeater. Each retransmission device 62 comprises a second short-range radio communication module 68 configured to communicate with each first radio communication module 60 via a short-range radio link 70, while a third long-range radio communication module 72 configured to communicate with the supervisory apparatuses 18 via a long-range radio link 74.

In a variant, the third radio communication module 72 and the radio link 74 form a high-penetration radio communication module and a high-penetration radio link.

By “short range”, is generally meant a distance of less than 100 m, such as a distance in the order of a few meters or a few tens of meters.

By “long range” is generally meant a distance greater than 100 m, it being understood that the long-range radio link 74 is capable of connecting two elements, such as the second radio communication module 68 and the gateway 66 more than 100 m apart, but that these two elements are not always separated by such a distance in practice.

By “high penetration” is meant the ability to penetrate thick walls with a thickness of several tens of centimeters or walls that do not facilitate the transmission of radio waves, such as reinforced concrete walls.

In addition optionally, at least one retransmission device 62 further comprises a base-shaped electrical connector for its power supply to network of light sources via an electrical power supply.

In addition optionally, when the supervisory equipment 12 also comprises the electronic tablet 24, the tablet 24 is configured to be connected, on the one hand, to the first radio communication module 60 via a corresponding short-range radio link 70, and, on the other hand, to the second radio communication module 68 via another short-range radio link 70.

Each short-range radio link 70 is for example compliant with IEEE 802.15.1, also called the Bluetooth standard, and preferably also compliant with the Bluetooth Low Energy standard, also called BLE or Bluetooth 4.0. The first and second radio communication modules 60, 68 and, if applicable, the electronic tablet 24 are then compliant with IEEE 802.15.1, more preferably BLE.

In a variant, each short-range radio link 70 complies with IEEE 802.11, also known as the Wi-Fi standard, the first and second radio communication modules 60, 68 and, if applicable, the electronic tablet 24 being then compliant with IEEE 802.11.

As a further variant, each short-range radio link 70 is of the RFID type, and thus the first and second radio communication modules 60, 68 and, if applicable, the electronic tablet 24 are of the RFID type.

In another variant, each short-range radio link 70 is an LPWAN (Low Power Wide Area Network) of preferably 2.4 GHz plus or minus 10%. The first and second radio communication modules 60, 68 and, if applicable, the electronic tablet 24 are thus of the LPWAN type. Such an LPWAN connection has the advantage of achieving low power consumption of the first and second radio communication modules 60, 68 and, if applicable, the electronic tablet 24.

In a variant, the long-range radio link 74 is preferably a radio link, more preferably a sub-GHz radio link, preferably between 700 MHz and 1 GHz, more preferably equal to 870 MHz plus or minus 10%, allowing long-distance communication or high-penetration through concrete. The third radio communication module 72 and the equipment that is connected thereto, such as the gateway 66 or the supervisory apparatus 18, are thus of the sub-GHz type.

In a variant, the long-range radio link 74 is an ultra-narrowband radio (UNB) link, the frequency band of this link having a width of less than 125 kHz. The third radio communication module 72 and the equipment that is connected thereto, such as the gateway 66 or the supervisory apparatus 18, are thus of the UNB type.

In a variant, the long-range radio link 74 complies with IEEE 802.11. The third radio communication module 72 and the equipment that is connected thereto, such as the gateway 66 or the supervisory apparatus 18, then comply with IEEE 802.11.

In another variant, the radio link 74 is a LPWAN (Low Power Wide Area Network) link, preferably 2.4 GHz plus or minus 10%, and the radio link 74 is then a high-penetration link. The third radio communication module 72 and the equipment that is connected thereto, such as the gateway 66 or the supervisory apparatus 18, are thus of the LPWAN type.

Each radio link 70, 74 is bidirectional to enable communication from each device for detecting changes in position 16 with the supervisory apparatus 18 or the electronic tablet 24, and vice versa, in order to also allow communication from the supervisory apparatus 18 to the device for detecting changes in position 16, and/or the electronic tablet 24, and/or the indicator light and/or the loudspeaker, in order to transmit the generated signal.

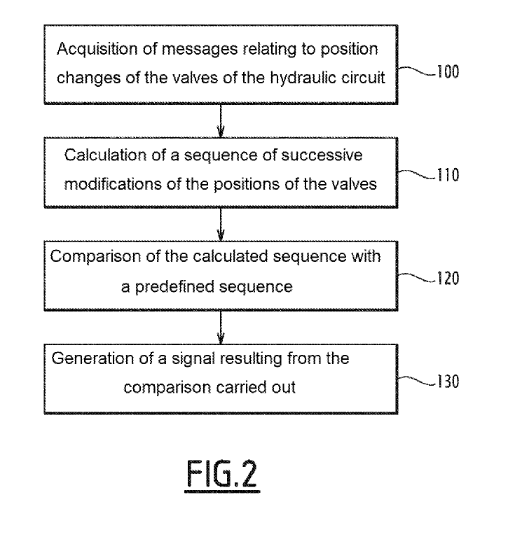

The operation of the supervisory equipment 12 will now be described with reference to FIG. 2 representing a flowchart of a method for supervising the valves 11 of the hydraulic circuit 10.

This supervisory method is configured to be implemented by each supervisory apparatus 18.

During an initial step 100, the calculation software 44 acquires messages transmitted by the different electronic devices 16 for detecting changes in position, each message containing information relating to a change of position of the corresponding valve 11.

The calculation software 44 then calculates, during the next step 110, the sequence of successive changes of the valve positions 11 from the acquired messages, each message containing not only the information relating to the change of position of the valve, but also a date associated with each change of position, thus allowing the calculation software 44 to define a chronology between the various changes of position.

The comparison software 46 then compares in step 120, the sequence calculated by the calculation software 44 with the predefined sequence, while the generation software 48 generates in step 130 a signal resulting from the comparison made during step 120, i.e. a signal based on the comparison between the calculated sequence and the predefined sequence.

In case of detection of a difference between the calculated sequence and the predefined sequence, the signal generated by the generation software 48 is a warning signal intended to warn the operator of this incident, so that he may then quickly correct it.

During this step 130, the generation software 48 is also able to generate an operating signal indicating the next operate to be performed by the operator, i.e. the next valve 11 to be operated according to the predefined sequence. In other words, the generation software 48 is configured to predict the next valve 11 to be operated based on the comparison made by the comparison software 46 between the calculated sequence and the predefined sequence.

As indicated above, various complementary means are intended to inform the operator of the generated signal. The generated signals are for example displayed on the electronic tablet 24 and/or the device for detecting changes in position 16 associated with the valve 11 corresponding to the signal.

Alternatively or optionally in addition, when the supervisory equipment 12 comprises at least one indicator light or at least one loudspeaker, the operator is informed of the generated signal in the form of a light signal emitted by the indicator and/or in the form of an audible signal emitted by the loudspeaker.

It is thus conceivable that the supervisory equipment 12 and the supervisory method make it possible to improve the supervision of the hydraulic circuit 10 by limiting the risk of an incident when the valves 11 are operated by operators, via the generation of the signal or signals, the warning signal intending to inform the operator of the detection of a difference between the sequence of the successive modifications of valve positions and the predefined sequence, and/or the operating signal intended to indicate to him more easily the next valve to be operated and so limit the risk of error.

What is claimed is:

1-16. (canceled)

17. Electronic equipment for supervising valves of a hydraulic circuit, each valve being movable between an open position and a closed position, the equipment comprising:
a plurality of electronic detectors configured for detecting changes in position, each electronic detector being associated with a respective valve and being configured to detect a change of position of the valve between an open position and a closed position,
an electronic supervisory apparatus configured for supervising the valves of the hydraulic circuit, and
a radio transmission system configured for radio transmitting messages between each electronic detector and the electronic supervisory apparatus, the electronic supervisory apparatus being configured to calculate a sequence of successive changes of the valve positions from messages received from the electronic detectors via the radio transmission system, to compare the calculated sequence with a predefined sequence, and to generate a signal based on the comparison between the calculated sequence and the predefined sequence.

18. The equipment according to claim 17, wherein the generated signal is a warning signal when a difference is detected between the calculated sequence and the predefined sequence.

19. The equipment according to claim 17, wherein the generated signal is an operating signal indicating a next valve to be operated according to the predefined sequence.

20. The equipment according to claim 17, wherein the electronic supervisory apparatus is further configured to identify the valve corresponding to the generated signal.

21. The equipment according to claim 20, wherein the electronic supervisory apparatus is further configured to transmit the generated signal, via the radio transmission system, to the electronic detector associated with the valve corresponding to the signal.

22. The equipment according to claim 20, further comprising an electronic tablet, the electronic supervisory apparatus being further configured to transmit the generated signal to the electronic tablet via the radio transmission system.

23. The equipment according to claim 20, further comprising at least one indicator light, each indicator light being associated with corresponding one of the valves, the electronic supervisory apparatus being further configured to transmit a control signal for generation by the indicator of a light signal via the radio transmission system to the indicator light associated with the valve corresponding to the generated signal.

24. The equipment according to claim 20, further comprising at least one loudspeaker, each loudspeaker being associated with a corresponding one of the valves, the supervisory apparatus being further configured to transmit, via the radio transmission system and to the loudspeaker associated with the valve corresponding to the generated signal, a control signal for generation by the loudspeaker of a sound signal.

25. The equipment according to claim 17, wherein each valve is rotatable about an axis of rotation between the open position and the closed position, each electronic detector comprising an accelerometer adapted to detect angular acceleration of the valve about the axis of rotation.

26. The equipment according to claim 25, wherein each electronic detector further comprises a power supply module and a calculation module configured to identify a change in the position of the valve as a function of the angular acceleration detected by the accelerometer, the power supply module being configured to electrically power the calculation module only upon detection of an angular acceleration by the accelerometer.

27. The equipment according to claim 17, wherein the radio transmission system comprises:
a plurality of first short range radio communication modules, each being associated with a respective one of the electronic detectors, and
at least one retransmission device configured for radio retransmission of messages between each first radio communication module and the supervisory apparatus, each retransmission device comprising:
a second short-range radio communication module configured to communicate with each first radio communication module, and
a third long-range radio communication module configured to communicate with the supervisory apparatus.

28. The equipment according to claim 27, wherein at least one retransmission device further comprises a base-shaped electrical connector for its power supply via a power supply network of light sources.

29. The equipment according to claim 27, wherein each third long-range radio communication module is configured to transmit and/or receive signals at a frequency less than 1 GHz.

30. The equipment according to claim 29, wherein each third long-range radio communication module is configured to transmit and/or receive signals at a frequency between 700 MHz and 1 GHz.

31. The equipment according to claim 30, wherein each third long-range radio communication module is configured to transmit and/or receive signals at a frequency equal to 870 MHz plus or minus 10%.

32. A hydraulic circuit comprising:
the plurality of valves movable between the open position and the closed position; and
the equipment according to claim 30.

33. A method for supervising valves of a hydraulic circuit, each valve being movable between an open position and a closed position, the method being implemented by computer and comprising:
acquiring messages transmitted by electronic detectors configured for detecting changes in position, each electronic detector being associated with a respective valve and being configured to detect a change of position of the valve between the open position and the closed position, each message containing information relating to the position of the corresponding valve;
calculating a sequence of successive modifications of the valve positions from the acquired message;
comparing the calculated sequence with a predefined sequence; and
generating a signal as a function of the comparison between the calculated sequence and the predefined sequence.

34. A non-transitory computer program product comprising software instructions, which, when executed by a computer, implement the supervisory method according to claim 33.
